(19) United States
(12) Patent Application Publication
(10) Pub. No.: US 2008/0055076 A1
(43) Pub. Date: Mar. 6, 2008

(54) Personal Articles Having Wireless Proximity Detectors

(76) Inventor: Steven S. Yu, Silver Spring, MD (US)

Correspondence Address: Steven S. Yu, 1111 University Blvd. W. # 907, Silver Spring, MD, 20902, US

(21) Appl. No.: 11/849,712

(22) Filed: Sep. 4, 2007

Related U.S. Application Data
(63) Continuation-in-part of application No. 11/687,547, filed on Mar. 16, 2007.
(60) Provisional application No. 60/824,482, filed on Sep. 5, 2006.
(60) Provisional application No. 60/826,036, filed on Sep. 18, 2006.

(51) Int. Cl. G08B 1/00

(52) U.S. Cl. 340/539.23

(57) ABSTRACT

A personal article, such as a handbag, comprising a wireless companion proximity detector system which includes one or more electronic components. The electronic components may be a transmitter for transmitting a signal, receiver for receiving a signal, or a notifier. In some cases, the wireless signals may be RF signals. In some cases, one or more of the electronic components are attached to the personal article.

### TECHNICAL FIELD

The present invention relates to personal articles, such as handbags.

### BACKGROUND

Counterfeit products are a major threat to the consumer goods industry. Among the most commonly counterfeited goods are fashion and luxury products such as handbags, watches, and apparel. Many of these counterfeit fashion and luxury products are now of such high quality that even experts are not able to easily identify them as counterfeits. Thus, various methods have focused on authenticating goods as they flow through the supply chain so that consumers would not unknowingly buy counterfeit products.

But these methods fail to address the problem of consumers who knowingly buy counterfeit products. In fact, many consumers are attracted to counterfeit products because of their lower cost and increasingly more often, their high quality. So how do you deter consumers from knowingly purchasing these counterfeit products?

### BRIEF DESCRIPTION OF THE DRAWINGS

FIG. 1 shows a front view (A), perspective view (B), and a cross-section side view (C) of a handbag according to one embodiment of the present invention.

FIG. 2 shows a handbag according to another embodiment of the present invention.

FIG. 3 shows a handbag according to another embodiment of the present invention.

FIG. 4 shows a top view (A) and a cross-section side view (B) of a strap on a handbag according to certain embodiments of the present invention.

FIG. 5 shows a coat according to another embodiment of the present invention.

FIG. 6 shows a watch according to another embodiment of the present invention.

FIG. 7 shows a cross-section side view of a portion of a handbag according to another embodiment.

FIG. 8 shows a front view (A) and a side view of a handbag according to another embodiment of the present invention.

FIG. 9 shows a perspective view of a handbag according to another embodiment of the present invention.

FIG. 10 shows a side view (A) and a front view (B) of a coin.

FIG. 11 shows a tag according to certain embodiments of the present invention.

FIG. 12 shows a handbag according to another embodiment of the present invention.

FIG. 13 shows a handbag according to another embodiment of the present invention.

### DETAILED DESCRIPTION

In one aspect, the present invention provides a personal article. As used herein, the term “personal article” includes carrying bags such as purses, handbags, clutches, pouches, backpacks, totes, luggage, briefcases, wallets or other types of bags that are carried on the person; and also, apparel items such as jackets, caps, hats, shoes, coats, belts; and also, personal accessories such as glasses, sunglasses, earrings, or watches.

The personal article comprises a wireless companion proximity detector system which includes one or more electronic components. The proximity detector system may include a transmitter which transmits a first wireless signal and a receiver which receives a second wireless signal. The second wireless signal is a signal being transmitted by a second transmitter in a companion personal article. In certain instances, both the personal article and the companion personal article are authentic personal articles.

Various wireless proximity detector systems are known in the art. U.S. Pat. No. 6,825,764 (Capobianco et al.) describes a user-programmable proximity detector which can be in the form of a keychain. The proximity detector includes various components, including a transmitter, receiver, modulator, demodulator, processor, memory, indicator, and user interface. U.S. Pat. No. 5,298,883 (Pilney et al.) describes a proximity alert system including a pair of portable electronic, coded transmitter/receiver units designed to operate in a specific signal band. The units include a receiver, transmitter, decoder, and encoder.

The transmitter may transmit any type of wireless signal. The wireless signal may be an electromagnetic signal, such as radio frequency (RF) or infrared. The wireless signal may be an acoustic signal, such as ultrasound. Various types of RF, infrared, and ultrasound transmitters are well known in the art. The wireless signal may digital, analog, or a combination of both.

In certain embodiments, the transmitter is an RF transmitter, of which various types and sizes are known in the art. For example, transmitters that are miniature in size, have low operating current requirements, and/or are battery-powered are suitable for use in the present invention. In some instances, the RF transmitter is integrated into a single chip.

The RF transmitter may transmit an RF signal in various ways. The transmitted signal may be digital, analog, or a combination of both. The signal may have certain identifying characteristics or protocols that would be recognized by a receiver of the signal. One of skill in the art will understand that the RF signal can have various characteristics, including operating frequency, amplitude, and modulation protocols. In some instances, the signal may be encoded or encrypted. These certain characteristics may be used to identify the source of the signal. For example, these certain characteristics may identify the source of the signal as being from an authentic personal article.

The receiver may receive any type of wireless signal. The wireless signal may be an electromagnetic signal, such as radio frequency or infrared. The wireless signal may be an acoustic signal, such as ultrasound. Various types of RF, infrared, and ultrasound receivers are well known in the art.

In certain embodiments, the receiver is an RF receiver, of which various types and sizes are known in the art. In certain embodiments, the RF receiver is miniature in size or integrated into a single chip.

The RF receiver may receive a radio signal in various ways. The received signal may be digital, analog, or a combination of both. The received signal may have certain identifying characteristics or protocols that would indicate the source of the signal. One of skill in the art will understand that the RF receiver can operate using radio signals of various characteristics, including operating frequency, amplitude, and modulation protocols. In some instances, the RF signal may be encoded or encrypted. These characteristics could indicate the source as being transmitted by a transmitter in an authentic companion personal article.

The signal recognized as being authentic need not be limited to a companion personal article made by the same brand or maker. The personal article and the companion personal article may be made by different brands or makers. As such, the signal being recognized as being authentic may come from another authentic personal article that is made by another brand or maker. Thus, one authentic personal article of one brand/maker may recognize another authentic personal article from another brand/maker. For example, a group of two or more brands/makers may establish a certain signaling protocol or encoding that would allow cross-brand recognition between their products.

In certain embodiments, the personal article may further comprise an antenna. The antenna may be used by either the transmitter to transmit signals, the receiver to receive signals, or both. The antenna may be located in any part of the personal article. For example, the antenna may be located in an internal part of the personal article. For example, the antenna may be in the lining of the personal article. In the case of a carrying bag, the antenna may be located in a strap. Any metal portions of the personal article, such as the metal buckles, chains, or rings on a handbag, may be used in assisting in signal transmission and/or reception.

In certain embodiments, the personal article further comprises a notifier. The notifier reports to the user of the personal article that the receiver has received or recognized a signal from another personal article in the vicinity. In certain instances, the notifier reports to the user of the personal article that the receiver has received or recognized a signal that is characteristic of an authentic signal from another authentic personal article in the vicinity. The notifier may be in communication with the receiver. The notifier may also be in communication with various other components of the wireless detection system, such as the microprocessor or decoder.

As used herein, the term “notifier” refers to any device which notifies or alerts a person by way of the person's various senses. Thus, notification may be visual, auditory, olfactory, or tactile. In some instances, the notifier may include a light-emitting device, such as a light-emitting diode (LED). In some instances, the notifier may produce a sound that is audible to the user. In some instances, the notifier may vibrate to notify the user.

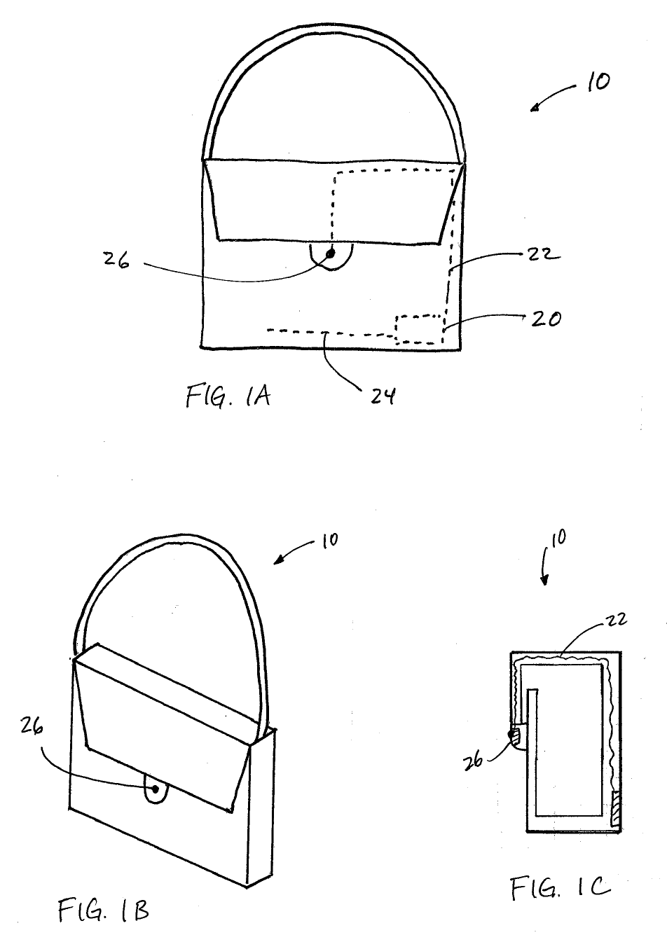

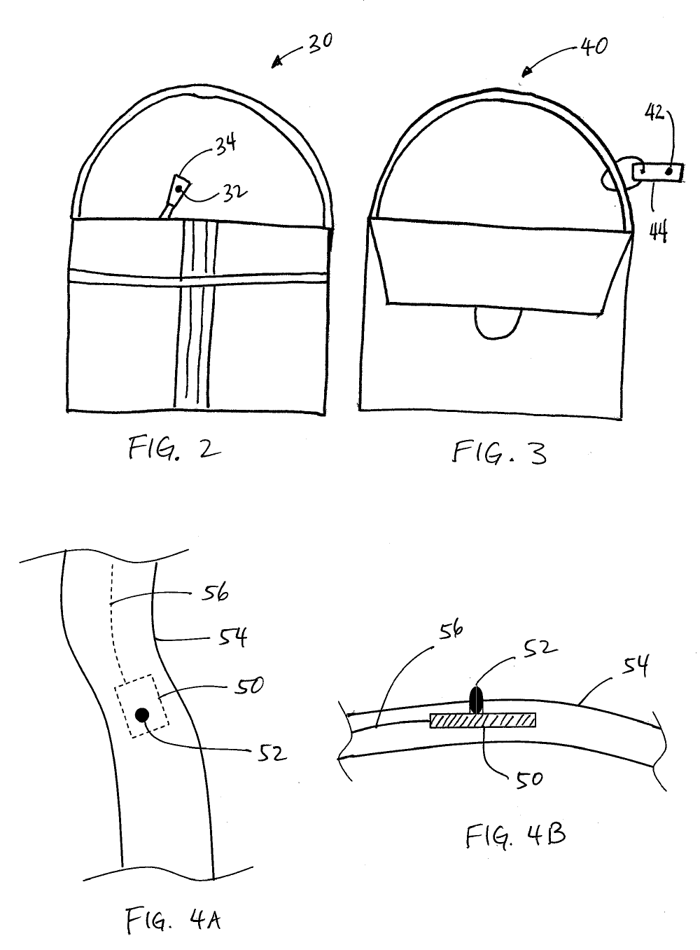

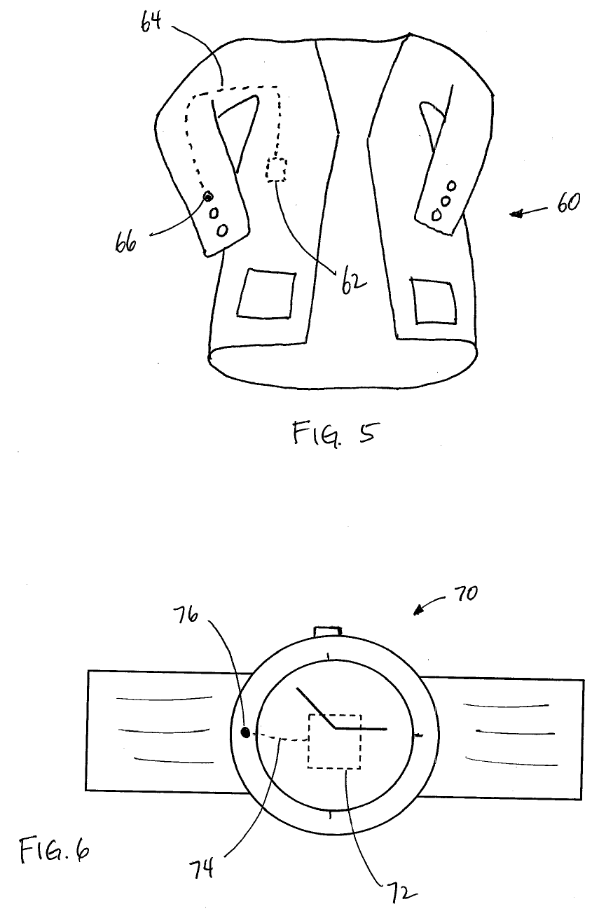

In one embodiment of the present invention, as shown in FIG. 1, a handbag 10 comprises a transceiver 20 having both a transmitter and a receiver. Transciever 20 is located inside the lining of handbag 10. Transciever 20 is coupled to an antenna 24 and a transmission line 22, which connects transceiver 20 to an LED notifer 26. In another embodiment, as shown in FIG. 2, a handbag 30 comprises an LED notifier 32 incorporated into a zipper 34. In another embodiment, as shown in FIG. 3, a handbag 40 comprises an LED notifier 42 incorporated into a tag 44. In another embodiment, as shown in FIG. 4, a transceiver and an LED notifier 52 are combined into a single component 50 that is located inside the strap 54 of a handbag. An antenna 56 is coupled to component 50. In another embodiment, as shown in FIG. 5, a transceiver 62 is located inside the lining of a coat 60. Via a transmission line 64, transceiver 62 is connected to an LED notifier 66 located on a button. In another embodiment, as shown in FIG. 6, a transceiver 72 is located inside a watch 70. Via a transmission line 74, transceiver 72 is connected to an LED notifier 76 located on the face of watch 70.

In certain embodiments, the personal article may further comprise a battery. The battery may supply power to any of the electronic components of the personal article, including the transmitter, receiver, microprocessor, and/or notifier. In certain instances, the notifier will indicate low battery power—e.g., by flashing intermittently.

In certain instances, one or more of the electronic components, such as the notifier, may be activated/deactivated. This feature may be used to preserve battery power. For example, the notifier may be deactivated at the time the personal article is being shipped from the manufacturing site. Then, at the retail site, the notifier may be activated. The electronic component may have a switch to turn it on/off, or may be activated/deactivated by an external signal, such as a magnetic or electromagnetic signal.

In certain instances, any of the electronic components, such as the notifier or transmitter, may go temporarily dormant after a period of continuous notification or continuous reception of a signal. This feature may preserve battery power. The dormant component may then resume working after the receiver stops receiving the signal—e.g., when the companion authentic personal article leaves the vicinity.

In certain instances, the system is designed to avoid sporadic or stuttering activation of the notifier. This feature can be provided in various ways known or readily available to one of ordinary skill in the art. For example, notifer may require a certain period of continuous signal reception by the receiver before becoming activated. In another example, once activated the notifier may be continuously activated for a certain period of time.

In certain instances, one or more of the electronic components may be powered passively by an external source of electromagnetic energy, such as a radio signal. For example, a receiver in a personal article may capture and use the electromagnetic energy in an electromagnetic signal that is being transmitted by a transmitter in another personal article. Such technologies are well-known in radio frequency identification (RFID) tags, such as passive RFID tags, which receive their electromagnetic energy from a RFID reader or scanner. In some cases, one or more of the electronic components may be powered both actively (by battery) and passively in combination.

The wireless companion proximity detector system may further include various other electronic components, such as a modulator, demodulator, encoder/encrypter, decoder/decrypter, memory, microprocessor, and/or other components that are used in wireless communication systems. In certain embodiments, the personal article may further comprise a microprocessor for processing signals that are being received or signals that are being transmitted. The microprocessor may be in communication with the transmitter, receiver, or both. For example, the microprocessor may control the signaling, or encode or encrypt signals being transmitted. The microprocessor may also control the reception, or decode or decrypt signals that are received. The microprocessor may also process the signal received and control the notifier. A memory associated with the microprocessor may store various data, including information identifying the personal article or the identities of other personal articles. For example, the memory may store a code that is unique to or identifies that specific personal article. The memory may also store codes that identify other personal articles. The memory may also be read-only or read/write (e.g., information received via the receiver may be stored in the read/write memory).

One or more of the electronic components may be in communication with one another. The communication may be direct or indirect (e.g., via another component, such as a microprocessor). For example, the transmitter may be in communication with the receiver. For example, the notifier may be in communication with the receiver. The communication link between the components may be a physical link or a wireless link.

In certain embodiments, the functionalities of one or more of the electronic components may be combined into a single unit. For example, the transmitter, receiver, and microprocessor may be combined into a single unit, such as an integrated circuit. In another example, the receiver and the notifier may be combined into a single unit. In some cases, the unit can be miniaturized. For example, the unit may be sized so that it can be incorporated into a small tag, which may be attached to the personal article. For example, the unit may be sized so that it can be disposed on or in a space-constrained personal articles, such as handbags or watches. In some cases, the functionalities of one or more of the electronic components may be integrated into a single chip (i.e., system-on-a-chip), such as those used for embedded radio-frequency systems.

In certain embodiments, one or more of the components are functionally separate or physically separate. For example, one or more of the components may be in physically separate units or housings. For example, the transmitter and the receiver may be in separate housings. The separate components may or may not be connected or in communication. For example, the transmitter need not be connected or be in communication in any way with the receiver.

In certain embodiments, signal transmission and signal reception occur in alternate intervals. In one example, this can be implemented in the following manner. The transmitter is activated for a certain period of time and then deactivated. While the transmitter is deactivated, the receiver is activated to receive signals for a certain period of time. Then, the receiver is deactivated and the transmitter is activated again. Thus, the signal transmission occurs at certain intervals, and the signal reception occurs between the intervals. The intervals can be set in various ways. For example, it may be a pre-set period of time, or in a pre-determined pattern, or random. This activation/deactivation cycle may be controlled by an electronic circuit or by a microprocessor. This is one of various ways to prevent self-detection. Other ways to prevent self-detection are also known in the art and can be used in the present invention, such as using encoded signals, or unique identifiers, or using any other type of signal carrying an identifying characteristic.

The proximity detector system may also employ any of various known techniques to prevent cloning of the system, protect against unauthorized reading, or provide enhanced security or privacy. For example, the system may use a “rolling code” scheme, wherein the identifier information changes after a certain time period or after each scan. In another example, the system may engage in challenge-response protocols where the transmitter in one personal article interacts with the receiver in another personal article using cryptographic protocols.

One of skill in the art will understand that the various electronic components of the wireless proximity detector system can be adjusted to control the maximum range at which signal detection occurs and/or at which notification occurs. For example, the transmitter may have a certain maximum range for transmission, or the receiver may have a certain maximum range for reception, or the notifier may only be activated after a certain signal strength threshold is exceeded.

Various ranges are suitable for use in the present invention, depending upon the type of personal article and the setting in which or the context in which the proximity detector system and the personal articles are being used. In certain instances, the range is the distance in which in-person social interaction between two people could ordinarily occur. For example, this range can be the distance at which face identification can be made. In another example, this range can be the distance in which ordinary conversation between two people at ordinary volume can take place. In another example, this range can be the distance in which a greeting (e.g., Hi, Hello, hand wave) between two people can ordinarily take place. In certain instances, the maximum range is less than 50 meters; and in certain instances less than 25 meters; and in certain instances less than 15 meters; and in certain instances less than 10 meters; and in certain instances less than 9 meters; and in certain instances less than 8 meters; and in certain instances less than 7 meters; and in certain instances less than 6 meters; and in certain instances less than 5 meters; and in certain instances less than 3 meters; and in certain instances less than 2 meters. In some instances, the range may be limited for privacy reasons.

One or more of the electronic components are disposed in or on the personal article. The electronic components may be disposed in or on the personal article in various ways. In certain embodiments, one or more of the electronic components are attached to the personal article. As used herein, the term “attached” is meant to include being attached, affixed, linked, tied, coupled, connected, fastened, joined to, bound, annexed, incorporated into, embedded, or in any way made to be a part of the personal article. For example, the electronic components may be attached by way of glue, latches, stitching, sewing, hooks, pins, staples, rings, chains, clasps, fasteners, or any other means for fastening.

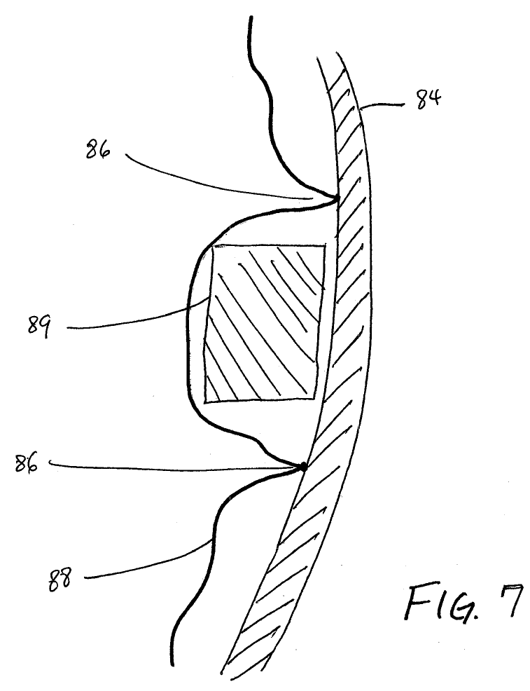

In certain instances, one or more of the electronic components (e.g., transmitter, receiver, and/or notifier) may be integrally attached to the personal article. As used herein, “integrally attached” refers to attaching in such a way that the electronic component (or any replacement thereof) is permanently attached to or is intended to remain a part of the personal article while in possession by the consumer/user. The fact that the electronic component can be temporarily removed for temporary purposes, such as maintenance, repair, service, replacement, or battery change does not exclude the electronic component from being integrally attached. Integrally attached is intended to include embedding, sewing into a lining, or enclosing within a compartment that is intended to be remained closed for the expected lifetime of the compartment or the personal article. For example, as shown in the cross-section side view of FIG. 7, a personal article (such as a handbag) may have an outer skin 84 and an inner lining 88. A receiver 89 is enclosed in a compartment within the inner lining 88. The compartment is defined by seams 86 that are formed by sewing the lining 88 onto the outer skin 84. Since the receiver 89 is intended to remain a part of the personal article while in possession by the consumer/user, the receiver 89 would be considered integrally attached to the personal article.

The fact that the object is capable of being removed by the consumer/user does not exclude the object from being integrally attached. For example, integrally attached is also intended to include attachment to the personal article via a coupler, such as a chain, link, line, cord, tie, lock, wire, string, or ring. For example, many handbags come with a tag that is attached to the handbag. FIG. 2 shows a tag on a zipper 34. FIG. 3 shows a tag 44 attached to a strap via a chain. Other handbags come with a lock attached. Although the consumer/user can break or unlatch the coupler and remove the tag, or unlock and remove the lock, the tag or lock is intended to remain a part of the personal article while in his/her possession. This means that the tag or lock is integrally attached. Various of the electronic components, including the notifier, may be incorporated into such a tag. In certain instances, the entire wireless proximity detection system may be incorporated into such a tag.

The fact that a component can be subsequently replaced with another component does not exclude it from being integrally attached. For example, in the case of an electronic component on a tag, the tag could be removed and be replaced by another tag containing a replacement electronic component. Such replacements may occur for various reasons, including expiration of battery life, or design changes, or upgrades. Nevertheless, such a tag and electronic component, whether the original or the replacement, is intended to remain a part of the personal article while in possession by the consumer/user, and is therefore integrally attached.

The electronic components may be located on any part of the personal article, including internal parts or external parts of the personal article. For example, the electronic components may be sewn into a personal article, embedded in the lining, etc. In another example, the electronic components may be located within compartments, pockets, or lining of the personal article.

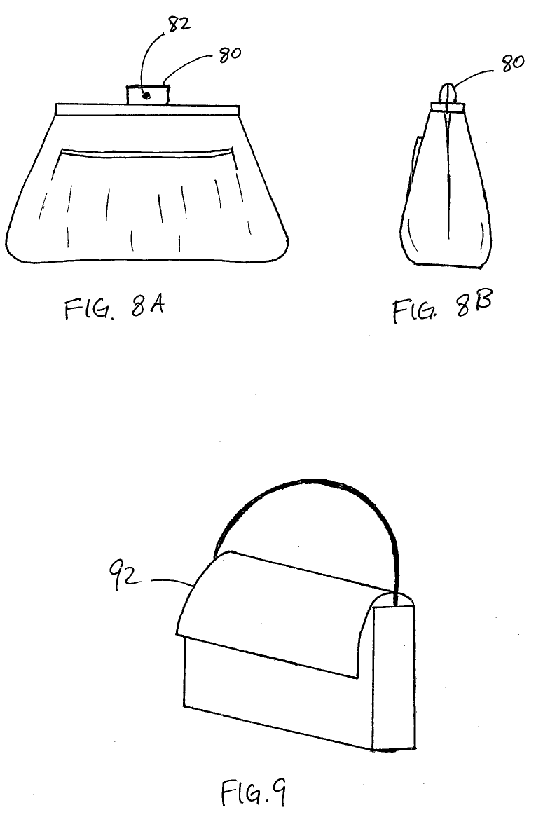

The electronic components may also be located on or incorporated into various parts, accessories, or hardware portions of the personal article, such as the zippers, buttons, clasps, latches, buckles, etc. For example, as shown in FIGS. 8A and 8B, an LED notifier 82 is incorporated into the clasp 80 of a handbag. In certain instances, one or more of the electronic components may be integrated into a functional, ornamental, stylistic, or design element of the personal article. For example, in the case of handbags, the electronic component may be integrated into a clasp, snap, button, buckle, strap, chain, hook, stud, zipper, trim, ring, or frame.

Where the electronic components are provided as separate units, they may be located in different parts of the personal article. For example, the receiver and transmitter may be in one part of the personal article, and the notifier in a different part. In another example, the transmitter and/or antenna may be located in the strap of a handbag, and the receiver located in a different part of the handbag.

In certain embodiments, one or more of the electronic components are designed in such a manner, and/or disposed in or on the personal article in such a manner, in order to be inconspicuous or to reduce or minimize any negative effect on the design, function, style, motif, or overall character of the personal article. This feature may be useful in certain products where consumers may feel that excessive electronic features would be “gimmicky.” This may be particularly true for high-priced fashion items, such as luxury handbags, watches, or coats. In such cases, any electronic features on the item, if not designed judiciously and/or used with moderation, may reduce the desirability, value, or marketability of the product. In such cases, the use of electronic features on the product may need to be discreet.

One of ordinary skill in the art, such as consumer product designers (e.g., in the case of handbags, designers of handbags), would understand how the electronic components should be designed or disposed in or on the personal article such as to reduce or minimize any negative effect on the design, function, style, motif, or overall character of the personal article.

For example, certain characteristics of the electronic component can be varied, such as its size in proportion to the size of the personal article, its shape, its texture, or its location on the personal article. In the case of the notifier, its brightness (for a light-emitting notifier) or its loudness or pitch (for an audible notifier) could be varied.

In certain instances, one or more of the electronic components may be hidden from an external viewpoint. For example, the transmitter and/or the receiver may be hidden in the lining of a handbag or coat. In another example, the notifier may be hidden in a pocket, compartment, or inside the flap of a handbag or coat. The pocket, compartment, or flap may be one that is easily accessible to the user of the personal article. For example, referring to FIG. 9, a notifier may be located on the inside of the flap 92 on a handbag.

In certain instances, where the personal article is a handbag, the notifier may be located externally on a back aspect, bottom aspect, or side aspect of the handbag. This feature may be useful in reducing the external visibility of the notifier to bystanders.

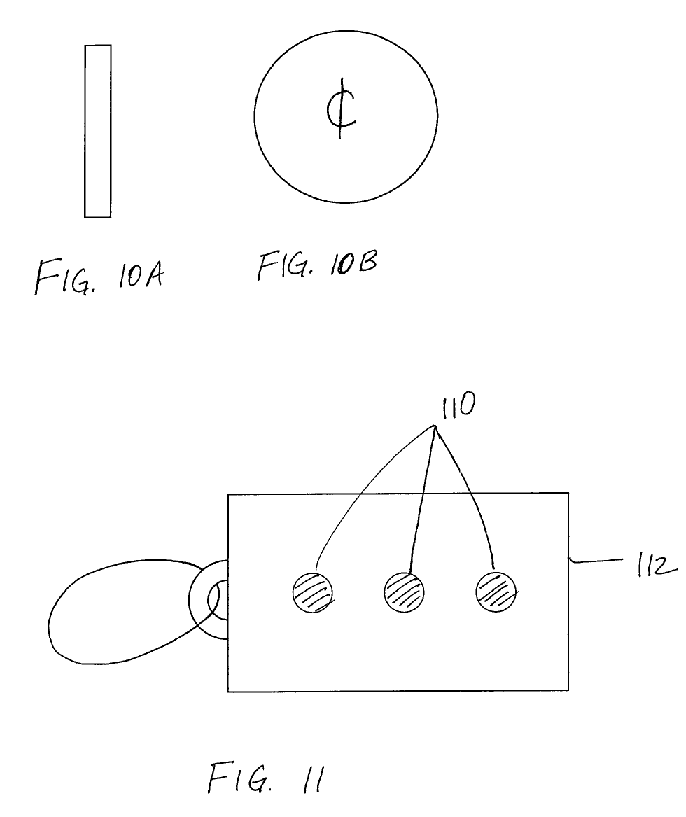

In certain instances, one or more of the electronic components may be designed such their dimensions are small in relation to the dimensions of the personal article. The dimensions of the electronic component may be measured in various ways. Where the components are housed within a housing, the dimensions include the housing. In some cases, the dimensions may be measured as the total outer surface area of the component. In some cases, the dimensions may be measured as the area of the maximum profile of the user-visible portion of the component. A profile is the two-dimensional representation of the object as viewed from a particular perspective. As used herein, “maximum profile” is the profile of the object as viewed from a perspective which gives the maximum area of profile. For example, FIGS. 10A and 10B shows a coin-shaped object, with FIG. 10A showing the coin's edge and FIG. 10B showing the coin's face. The maximum profile of the coin is the profile from the perspective of directly viewing the face of the coin. For example, in the case of an electronic component incorporated into a tag, the maximum profile is obtained when directly viewing the face of the tag.

The term “user-visible” refers to that portion of the object that is or intended to be visible to the user. For example, the object may be in a closed, but easily accessible pocket. Nevertheless, it may be intended to be visible to the user when the user simply opens the pocket. On the other hand, part of the object may be embedded in the personal article, and therefore intended to be hidden from view. That part of the object that is intended to be hidden from view is not counted as being user-visible. For example, referring to FIG. 4B, LED notifier 52 is intended to be visible to the user. However, component 50 is intended to be hidden from view inside the strap and therefore, is not counted as being user-visible.

In some instances, where the notifier is a light-emitting notifier, its dimensions may be measured as the total area of the maximum profile of the light-emitting portions of the notifier. For example, FIG. 11 shows a series of LEDs 110 on a tag 112. The total area of the maximum profile of the light-emitting portions is the sum of the profiles of each of the LED lights as viewed directly into the face of the tag.

In certain instances, the dimensions of the personal article may be measured by the area of the maximum profile of the personal article in a condition in which the personal article would ordinarily be displayed in a retail setting. For example, in the case of a handbag, the maximum profile of the bag shown in FIG. 1B is obtained by the view shown in FIG. 1A. Also as shown in FIGS. 1A and 1B, in a retail setting, the handbag would ordinarily be displayed in an uncompacted state and with the flap closed. In another example, in the case of a coat, it would ordinarily be displayed hanging from a rack or on a mannequin. In another example, in the case of a watch, it would ordinarily be displayed on a model of a wrist.

In some instances, the dimensions of one or more of the electronic components, such as the notifer, is less than 30% of the dimensions of the personal article; and less than 20% in some instances; and less than 15% in some instances; and less than 10% in some instances; and less than 5% in some instances; and less than 3% in some instances; and less than 1% in some instances.

In some instances, the area of the maximum profile of the user-visible portion of one or more of the components, such as the notifier, is less than 30% of the area of the maximum profile of the personal article as ordinarily displayed in a retail setting; and in some instances less than 20%; and in some instances less than 15%; and in some instances less than 10%; and in some instances less than 5%; and in some instances less than 3%; and in some instances less than 1%.

In some instances, where the notifier uses a light-emitting device, the total area of the maximum profile of the light-emitting portions of the notifier is less than 20% of the area of the maximum profile of the personal article as ordinarily displayed in a retail setting; and in some instances less than 15%; and in some instances less than 10%; and in some instances less than 5%; and in some instances less than 3%; and in some instances less than 1%.

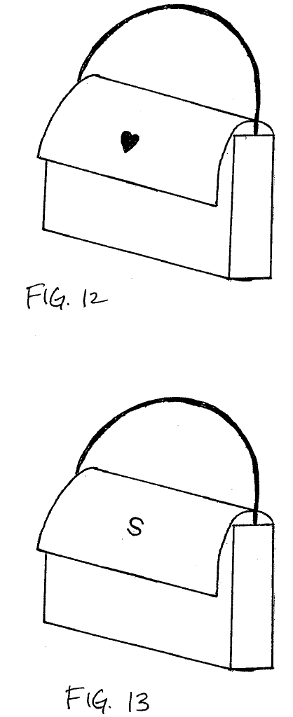

In certain embodiments, one or more of the electronic components may be disposed in or on the personal article to enhance any design, character, motif, stylistic element, or function of the bag. For example, the notifier itself may be an ornamental or design feature of the bag. For example, the notifier may be in the shape of a logo, heart, or diamond. For example, as shown in FIG. 12, the notifier may be incorporated into the logo, or made into the shape of a logo. Here, the logo letter “S” is lit up by LEDs. In another example, as shown in FIG. 13, the notifier may be in the shape of a heart that is lit by LEDs.

The wireless companion proximity detector system may further comprise other useful electronic features. For example, the wireless detector system can be adapted to have additional features so that it could be used in anti-theft systems, other anti-counterfeiting systems such as product authentication systems, point-of-sale systems, smart tag systems, or inventory systems.

In another aspect, the present invention provides a system. The system may be used for deterring the purchase of counterfeit products, such as counterfeit personal articles. The system may comprise a plurality of personal articles, such as carrying bags. In some cases, the personal articles are authentic personal articles. Each of the plurality of personal articles has one or more electronic components disposed therein or thereon.

In certain embodiments, the system further comprises a plurality of transmitters, wherein each of the transmitters is attached to each of the plurality of personal articles. A receiver and notifer are attached to at least one of the personal articles. In some instances, any of the electronic components, including the transmitter, receiver, or notifier, is integrally attached to the personal article. When a first one of the personal articles having a receiver and a notifier comes into proximity to a second one of the personal articles having a transmitter that transmits a signal, the receiver on the first personal article receives the signal, and in response, the notifier is activated.

In another aspect, the present invention provides a method of manufacturing a personal article, such as a carrying bag. In certain embodiments, the method comprises providing a personal article. One or more electronic components, such as a transmitter, a receiver, and/or a notifier are disposed in or on the personal article. The electronic components may be disposed in or on the personal article by attaching or integrally attaching to the personal article. One or more of the electronic components may be combined and disposed in or on the personal article as a single unit. For example, the transmitter, receiver, and notifier may be a disposed in or on the personal article as a single unit.

In another aspect, the present invention provides a method of deterring the purchase of counterfeit products, such as personal articles. In certain embodiments, the method comprises providing one or more personal articles. One or more electronic components, such as a transmitter, a receiver, and/or a notifier are disposed in or on the personal articles. For example, the electronic components may be attached or integrally attached to the personal articles. One or more of the electronic components may be combined and disposed in or on the personal article as a single unit. The method may further comprise deploying the personal articles. As used herein, “deploying” refers to dispatching, shipping, delivering, or otherwise distributing or sending the products for sale or distribution in the marketplace

In any of the methods of the present invention, the steps of the method may be performed in a different order. Also, any of the steps, including the steps of “attaching” or “integrally attaching” may be performed simultaneously. For example, although the steps of attaching a receiver and attaching a notifier may be described separately, they may in fact be performed simultaneously as a single step.

One of the uses for the present invention is to deter consumers from the purchase of counterfeit products and/or encourage the purchase of authentic products. The deterrence may work by altering consumer behavior to reduce the demand for counterfeit products. In this manner, the personal article of the present invention has now gained a new synergistic effect—to cause social embarrasment for someone who possesses a counterfeit product. This is illustrated in the following example of certain embodiments of the invention: Person A and Person C are acquaintances. Person A is carrying an authentic handbag having a wireless companion proximity detector as described herein. Person C is carrying a counterfeit handbag. When Person A and Person C encounter each other, the notifier on the Person A's authentic handbag does not activate because Person C's handbag is a counterfeit. Thus, Person A will thus know that Person C's handbag is not authentic. Person C is aware or becomes aware that authentic handbags are able to detect and notify the user of other authentic handbags in the vicinity, but not counterfeit handbags. Thus, Person C suffers social embarrasment that the counterfeit nature of the handbag has been exposed. In order to avoid such embarrassment, Person C will prefer to purchase the authentic handbag and be deterred from purchasing counterfeit handbags.

The present invention may be used by one maker or brand of products. For example, a particular maker/brand may use the present invention for all or some of their products. The products may include a mix of various types of products (e.g., handbags, shoes, and sunglasses, all made by same maker/brand).

The present invention may also be used by a group of brands/makers. An authentic personal article from one brand/maker may be able to recognize an authentic personal article from another brand/maker. Such cross-recognition may be achieved by collaboration or agreement. For example, a group of brands, makers, or manufacturers, may establish a certain signal protocol that would be mutually recognized by their products.

The foregoing description and examples have been set forth merely to illustrate the invention and are not intended to be limiting. Each of the disclosed aspects and embodiments of the present invention may be considered individually or in combination with other aspects, embodiments, and variations of the invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention.

I claim:

1. An article of manufacture, comprising:
a carrying bag;
a first transmitter for transmitting a first wireless signal, wherein the first transmitter is attached to the carrying bag;
a receiver for receiving a second wireless signal, wherein the receiver is attached to the carrying bag, and wherein the second wireless signal is transmitted from another carrying bag having a second transmitter; and
a notifier for reporting the reception of the second wireless signal, wherein the notifier is integrally attached to the carrying bag, and wherein the notifier is activated when the receiver receives the second wireless signal.

2. The article of claim 1, where the first transmitter and the receiver are combined into a single unit.

3. The article of claim 1, wherein the first transmitter and the receiver are separate units.

4. The article of claim 1, wherein the notifier is in communication with the receiver.

5. The article of claim 1, wherein the transmission of the first wireless signal by the first transmitter and the reception of the second wireless signal by the receiver occurs at alternating intervals.

6. The article of claim 1, wherein the notifier includes a light-emitting diode.

7. The article of claim 1, wherein the area of the maximum profile of the user-visible portion of the notifier is less than 10% of the area of the maximum profile of the personal article as ordinarily displayed in a retail setting.

8. The article of claim 1, wherein the first transmitter is integrally attached to the carrying bag.

9. The article of claim 1, wherein the receiver is integrally attached to the carrying bag.

10. The article of claim 1, wherein the first transmitter has a maximum range of 50 meters or less.

11. A system comprising:
a plurality of carrying bags;
a plurality of transmitters, wherein each of the plurality of transmitters is attached to each of the plurality of carrying bags;
at least one receiver, wherein the at least one receiver is attached to at least one of the carrying bags; and
at least one notifier, wherein the at least one notifier is integrally attached to the at least one carrying bag having the receiver attached thereto;
wherein when a first one of the carrying bags having a receiver and a notifier comes into proximity to a second one of the carrying bags having a transmitter that transmits a signal, the receiver on the first one of the carrying bags receives the signal, and in response, the notifier is activated.

12. The system of claim 11, wherein each of the transmitters is integrally attached to each of the carrying bags.

13. The system of claim 11, wherein the at least one receiver is integrally attached to the at least one carrying bag.

14. The system of claim 11, wherein the proximity range is 50 meters or less.

15. A method for deterring the purchase of counterfeit carrying bags, comprising:
providing a first carrying bag;
attaching a transmitter to the first carrying bag, wherein the transmitter transmits a wireless signal;
providing a second carrying bag;
attaching a receiver to the second carrying bag, wherein the receiver receives the wireless signal from the transmitter attached to the first carrying bag;
integrally attaching a notifier to the second carrying bag, wherein the notifier is activated when the receiver receives the wireless signal; and
deploying the first carrying bag and the second carrying bag.

16. The method of claim 15, wherein the transmitter is integrally attached to the first carrying bag.

17. The method of claim 15, wherein the receiver is integrally attached to the second carrying bag.

18. The method of claim 15, wherein the maximum range of the communication between the transmitter and the receiver is 50 meters or less.

19. The method of claim 15, wherein the maximum range for activation of the notifier is 50 meters or less between the transmitter and the receiver.

20. The method of claim 15, further comprising:
attaching another receiver to the first carrying bag;
integrally attaching another notifier to the first carrying bag; and
attaching another transmitter to the second carrying bag.
